(19) United States
(12) Patent Application Publication
(10) Pub. No.: US 2023/0279912 A1
(43) Pub. Date: Sep. 7, 2023

(54) Disc brake arrangement having a circumferentially contacted brake disc

(71) Applicant: HL MANDO CORPORATION, Pyeongtaek (KR)

(72) Inventor: Hatem SHAHIN, Pfaffenhofen (DE)

(21) Appl. No.: 18/178,510

(22) Filed: Mar. 5, 2023

(30) Foreign Application Priority Data
Mar. 4, 2022 (DE) 102022202251.3

(51) Int. Cl. F16D 65/00; F16D 65/08

(52) U.S. Cl. CPC F16D 65/0031; F16D 65/08

(57) ABSTRACT

The invention concerns a disc brake arrangement for a vehicle, in particular a road vehicle, comprising: a brake disc that is rotatable about a rotation axis; at least one brake pad having a brake lining and being movable to contact an outer circumferential face of the brake disc for generating a brake force.

### CROSS-REFERENCE TO RELATED APPLICATION

This application is based on and claims priority under 35 U.S.C. § 119 to German Patent Application No. 102022202251.3, filed on Mar. 4, 2022 in the German Patent and Trade Mark Office, the disclosures of which are incorporated herein by reference.

### TECHNICAL FIELD

The invention concerns a disc brake arrangement for a vehicle, in particular a road vehicle and more specifically a non-track bound vehicle. The vehicle may e.g. be a car, a truck or a bus.

### BACKGROUND

Disc brakes are widely used as wheel brakes for road vehicles. They typically comprise a brake disc that is mechanically coupled to a wheel for a joint rotation therewith. A brake pad is, with respect to a rotational axis of the brake disc and of the vehicle wheel, axially movable relative to the brake disc. For generating a brake force, the brake pad contacts the brake disc, thereby slowing down the brake disc's rotation and the rotation of the vehicle wheel.

Typically, the brake disc is axially clamped between two brake pads that are arranged at opposite side faces of the brake disc. The brake pads are carried by a brake caliper that axially spans across the brake disc.

An example of a respective disc brake can e.g. be found in DE 10 2013 001 300 B4.

While such a design of a disc brake is established and proven, there remains room for improvement. For example, existing disc brakes often show undesired levels of mechanical vibrations and/or noise generation, especially squeal noise. Also, they can generate an undesired level of brake dust emission into the surroundings. Further known drawbacks concern the following: a corrosion of the brake disc, in particular at its side faces which are contacted by the brake pads; a tendency to cause non-symmetric pad wear; an axial expansion of a brake caliper housing under high pressure, e.g. causing an undesired brake pedal feel and/or vibrations; a conning of the brake disc due to unequal thermal loading of its opposite side faces; an excessive heating of a caliper piston and/or caliper housing; a high level of additional brake fluid absorption within a caliper cavity, in particular due to a deformation of the brake caliper under pressure; an increased weight of the overall brake system.

### SUMMARY

It is thus an object of the present invention to provide a disc brake design which helps to remedy at least some of these existing disadvantages.

This object is solved by the subject matter according to the independent claim. Advantageous embodiments are defined in the dependent claims and in this description.

Accordingly, a disc brake arrangement for a vehicle is suggested, in particular a road vehicle according to any of the above-mentioned examples, the disc brake arrangement comprising:
a brake disc that is rotatable about a rotational axis;
at least one brake pad having a brake lining and being movable to contact an outer circumferential face of the brake disc for generating a brake force.

Terms used herein such as axial, radial and circumferential may refer to the rotational axis. A radial direction may extend at an angle to said rotational axis and in particular orthogonally thereto. An axial direction may extend along said rotational axis. A circumferential direction may extend about or around the rotational axis.

The brake disc may be a single part member or a multi-part member, e.g. having a hub and a radially outer ring member that are attached to one another. It may generally be flat and/or circular. It may comprise a hub, in particular a wheel hub or axle hub. The hub may be configured as an axially protruding portion, in particular a central axially protruding portion. Said axially protruding portion may protrude to only one side and/or in only one axial direction, or to both sides and/or in both axial directions. In one example, the hub axially protrudes relative to a radially outer section (in particular a ring section) of the brake disc.

Alternatively, the brake disc may be free of substantial axial protrusions or at least free of only one-sided or one-directional axial protrusions. For example, the disc member may be planar and/or may be substantially mirror symmetric with respect to a cross-sectional plane extending orthogonally to the rotation axis.

The brake disc may be massive or may at least partially be hollow. Hollow portions may e.g. be defined by hollow spaces within the disc member or by channels or drillings within the brake disc. This helps to reduce weight. Also, the hollow portions may be a design feature to improve thermal and/or mechanical characteristics of the brake disc.

The brake pad may be positioned opposite the outer circumferential face of the brake disc, in particular radially opposite thereto. Further, at least when not braking it may be positioned radially outside or at a radial distance to the brake disc. For contacting the brake disc, the brake pad may be (preferably exclusively) radially displaceable. The brake pad may generally be displaceable along a linear movement path.

The brake pad may be configured to generate frictional forces when contacting the brake disc, thereby slowing down a rotation of the brake disc and thus slowing down the vehicle.

The disc brake arrangement may comprise at least one actuator for displacing the brake pad, e.g. a hydraulic or electric actuator. This actuator may be comprised by a brake caliper, or generally put, a brake pad carrier to which the brake pad is coupled. The brake pad carrier may be stationary within the vehicle. It may comprise a displaceable member, such as a piston or spindle, as well as a hydraulic chamber or electric motor acting on said displaceable member. The displaceable member may be coupled to the brake pad, thereby carrying it and/or being able to displace it in order to contact the brake disc.

The brake lining may form or be attached to a face of the brake pad that is (radially) opposite to and/or that faces the outer circumferential face of the brake disc. The brake lining may, at least initially, have a constant radial thickness. It may extend along at least part of the circumferential face of the disc member. The brake lining may be correspondingly shaped to said outer circumferential face, e.g. by being similarly curved.

The brake lining may be configured according to any known configurations in terms of materials and/or thickness and/or friction coefficient, but may be positioned differently compared to the prior art. For example, instead of being axially movable to contact a side face of the brake disc, it may be radially movable to contact the brake disc's circumferential face. The bake lining may be connected to (e.g. mechanically and/or by glueing) a back plate or shim.

Optionally, the brake lining is replaceable. For example, it may be removably attached to the brake pad, e.g. by means of said mechanical fixing elements. This allows for replacing it when worn out, although the brake lining can optionally be dimensioned to have a long service life which might not require replacing it.

For example, the brake lining may be sized, e.g. in terms of thickness and/or volume, to cover a defined total operating life cycle of a given vehicle and based on an expected extent of brake activations. This life cycle may e.g. include 250.000 kilometers of driving distance or a ten years driving period. This may help to limit operating costs.

The disc member, on the other hand, may be free of any brake lining.

The disclosed disc brake arrangement may provide a number of advantages. For example, the brake disc may thermally expand predominantly in a radial direction. The brake disc may e.g. comprise a material having a large heat capacity, such as a metallic material and in particular cast iron. The predominant radial expansion may improve brake performance, e.g. by avoiding or even reversing an undesired increase in brake pedal travel. Specifically, an increase in a radial distance between the brake disc and brake pad that would affect the brake pedal travel may be prevented or even reversed. This may counteract potential increases in a radial distance between the brake pad and brake disc that could otherwise occur, e.g. due to less favourable thermal expansions and/or deformations of a hydraulic piston chamber (i.e. caliper cavity) under load. On the other hand, given that no frictional forces may be generated at the side faces of the brake disc, an uneven axial thermal expansion can be avoided.

At the same time, a risk of drag torque may be reduced. This is because radial oscillations of the brake disc which could cause such drag torque can be significantly smaller than axial oscillations. In existing brake disc designs, the latter may lead to undesired contacts between the brake pad and brake disc, thus causing drag torque even when not activating the brake.

The curved shape of the brake disc's circumferential face and optionally of the brake lining further decreases a risk of large planar contact areas being formed that could cause significant drag torque when the brake is not activated. Moreover, a risk of aerodynamic suction forces that in existing brake disc designs likewise cause drag torque can significantly be reduced when braking at a circumferential face of the brake disc.

Apart from reducing drag torque, the prevention of undesired contacts between the brake pad and brake disc when not braking may also help to limit low frequency noises, such as rattle, moan, groan or howl noises.

Further, generating braking forces at the outer circumferential face of the brake disc may (compared to existing designs with a brake force generation at the side faces) allow for reducing the radius of the brake disc while e.g. maintaining an effective braking radius (i.e., maintaining a distance to the rotational axis at which the brake forces are generated). Thus, the size and weight of the brake disc can be reduced compared to prior art designs, while achieving a similar brake performance.

Also, it has been found that the disclosed relative arrangement and interaction of the brake pad and brake disc may help to improve vibration characteristics of the disc brake. Accordingly, the generation of undesired brake noises may be limited and in particular of squeal noises. For example, with the presently disclosed brake disc the number of Eigenfrequencies (in particular in the frequency scale from 1000 Hz to 6000 Hz) and/or the number of out of plane modes of the brake disc may be reduced compared to existing designs. An axial mode coupling of vibrations to adjacent components may likewise be reduced.

Braking at the outer circumferential face may also prevent disc tilting or disc coning occurring in the existing solutions that brake at the disc's side faces. Likewise, homogeneity of brake lining wear may be improved (e.g. due to less radial vibrations compared to axial vibrations and/or more uniform radial thermal expansion of brake disc and brake lining).

Further, with the disclosed design, brake dust will be generated at the circumferential face of the brake disc. There, it can more easily be collected and/or shielded from the surroundings or may even be guided away from the surroundings, e.g. by means of some of the below discussed embodiments.

According to a further embodiment, the brake lining comprises a friction material, the friction material for example comprising friction fibres or friction particles (e.g. metallic particles) and a binder. Accordingly, the friction material may be or comprise a material composition with particles and/or fibres distributed in a (rigid) binder material.

Additionally or alternatively, the outer circumferential face of the brake disc may be made from a material that is different from the material of the brake lining, e.g. that is not a friction material and/or that is not a brake lining material. This may allow to provide suitable individual material selections for each of the disc member, the brake lining and/or the brake pad, e.g. with regard to any of weight, rigidity, hardness, friction coefficient or thermal expansion.

In one example, the outer circumferential face of the brake disc (or the complete brake disc) comprises a material that is harder than a material of the brake lining. This reduces wear of the outer circumferential face compared to the brake lining. Additionally or alternatively, a friction coefficient of the contact surface may be smaller than that of the friction material.

According to one embodiment, the disc brake comprises a metallic material (e.g. cast iron) and/or is a one-piece metallic member. This may provide a particular stable brake disc having preferred vibration characteristics. In case of a multi-member design, a radially inner hub portion of a first material (e.g. aluminum) may be connected to a radially outer ring portion comprising the outer circumferential face. The radially outer ring portion may be made of a second material, e.g. cast iron. Any cast iron material mentioned in this disclosure may be a spheroidal graphite iron material. By using a metallic material and in particular cast iron for the brake disc, a preferable thermal expansion characteristic can be achieved. The brake pad and/or brake lining, to the contrary, may not be a metal cast part and/or may not be made of or comprise cast iron. This helps to reduce weight.

The brake lining may have a contact surface for contacting the outer circumferential face of the brake disc, the contact surface being curved correspondingly to said outer circumferential face. Differently put, a curvature or shape of the faces of the brake lining and outer circumferential face may match each other, e.g. to define an areal and consistent abutment therebetween. For example, the outer circumferential face may be convexly curved, whereas the contact surface of the brake lining may be (correspondingly) concavely curved. This improves uniformity of wear and brake force generation.

In one aspect, the disc brake arrangement further comprises at least one brake pad carrier (or, put differently, brake caliper) to which the brake pad is mounted.

The brake pad carrier may have at least one shielding section that radially protrudes relative to the brake lining, in particular radially inwards. The shielding section may thus be arranged (e.g. with the brake pad carrier being stationary) or be arrangeable (e.g. with the brake pad carrier being displaceable) axially adjacent to a section of the outer circumferential face of the brake disc and/or axially adjacent to a side face of the brake disc.

The shielding section may be part of and in particular may form an edge of a recess formed in the brake pad or brake pad carrier. The outer circumferential face of the brake disc may at least partially be received (e.g. also when not braking) or receivable (e.g. at least when braking) in said recess. For example, the recess may be configured as a circumferential slot or circumferential groove in which an outer rim portion of the brake disc comprising the outer circumferential face can be inserted and thus received. A rotation of the brake disc relative to the brake pad or brake pad carrier may be unobstructed by the recess.

The brake lining may be arranged at a portion of the recess facing the outer circumferential face. Said portion may form a bottom face of the recess. The shielding section may form a radially protruding side portion or edge portion of the recess. It may not contact the outer circumferential face or any other face of the brake disc during braking. Specifically, the shielding section may radially overlap with the brake disc. There may be two parallel shielding sections that are axially spaced from one another.

By arranging the brake lining in a respective recess and/or by providing a respective shielding section, the emission of brake dust into the surroundings can be limited. Also, the recess and shielding section may provide a noise absorbing function during braking.

An axial outer face of the brake disc may generally be referred to as a side face. The brake disc may have two side faces that face in opposite axial directions and that are connected by the circumferential face of the brake disc.

In this context, the brake pad or brake pad carrier may comprise a first shielding section portion and a second shielding section portion which are arranged or arrangeable adjacent to different (e.g. opposite) axial outer faces of the brake disc king. Put differently, the brake disc may be arrangeable in a space between and/or may be axially surrounded by the first and second radial shielding sections. This provides a particularly efficient reduction of noise and dust emissions.

The brake pad and in particular an optional brake pad carrier may comprise at least one dust collecting member. The dust collecting member may e.g. comprise at least one surface (e.g. coated with or comprising an adhesive) to which brake dust may adhere. Additionally or alternatively, it may comprise a porous material and/or a filter material, thus providing a material structure for absorbing brake dust. The dust collecting member may be removably mounted to the brake pad or brake pad carrier in order to be replaceable when having collected a large volume of dust.

The at least one dust collecting member may be placed at one of a trailing or leading edge of the brake pad carrier with respect to a forward rotating direction of the brake disc (i.e. a direction of rotation during forward travelling of the vehicle). Alternatively, it may be placed at an inner side of the shielding section, said inner side facing the brake disc. If more than one dust collecting member is provided, any combinations of the disclosed positions may be provided (e.g. at a trailing edge or leading edge or inner side).

Additionally or alternatively, the outer circumferential face of the brake disc may comprise a recess in which the brake pad and in particular its brake lining is at least partially received (e.g. also when not braking) or receivable (e.g. at least when braking). For example, a surface section of said outer circumferential face that is contacted by the brake lining may form a bottom part of said recess. Edge or side portions of the recess may be axially spaced apart from one another and/or may radially protrude outwards relative to said contacted surface section. The edge or side portions may not be connected by the brake pad during braking. They may provide a noise or dust shielding function. At least one dust collecting member of the above-mentioned type may be provided at an axially inner side of any of said side or edge portions. In one example, the brake lining comprises at least one groove in a contact surface for contacting the outer circumferential face of the brake disc. The groove may e.g. extend circumferentially or axially while defining a radial indentation. An axial width of the groove may be e.g. between (and including) 1 and 3 millimeters, in particular 2 to 3 millimeters. A radial depth may be between (and including) 4 and 6 millimeters. The groove may help to guide brake dust in a desired manner and/or help to improve vibration and noise characteristics.

### BRIEF DESCRIPTION OF DRAWINGS

Embodiments of the invention are described in further detail below with respect to the attached schematic figures. Same features may be marked with the same reference signs throughout the figures.

FIG. 1-4 show different configurations of brake discs for disc brake arrangements according to embodiments of the invention.

FIGS. 5-6 show a brake pads for disc brake arrangements according to embodiments of the invention.

FIGS. 7-9 show variants of arranging brake pads relative to a brake disc according to embodiments of the invention.

FIG. 10 is a partial view of a disc brake arrangement according to an embodiment of the invention and with a recess in the brake disc;

FIG. 11 is a partial view of a disc brake arrangement according to an embodiment of the invention and with a recess in a brake pad carrier;

FIG. 12 is a partial view of a disc brake arrangement according to an embodiment of the invention and with grooves in a brake lining;

FIG. 13 is a partial view of a disc brake arrangement according to an embodiment of the invention and with dust collecting members at the brake pad;

FIGS. 14-16 show variants of arranging a dust collecting member at a brake pad according to embodiments of the invention.

### DETAILED DESCRIPTION

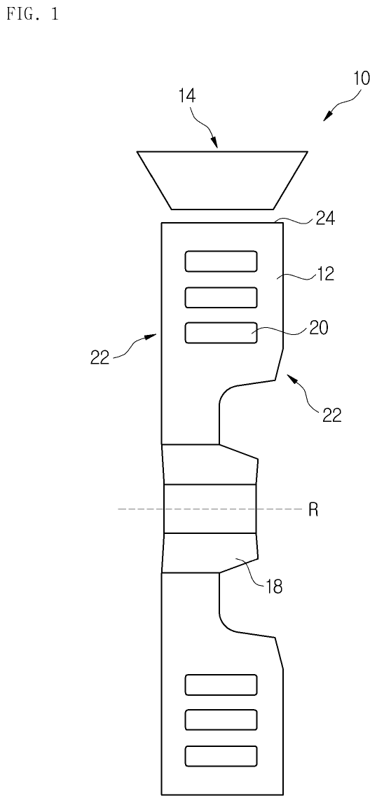

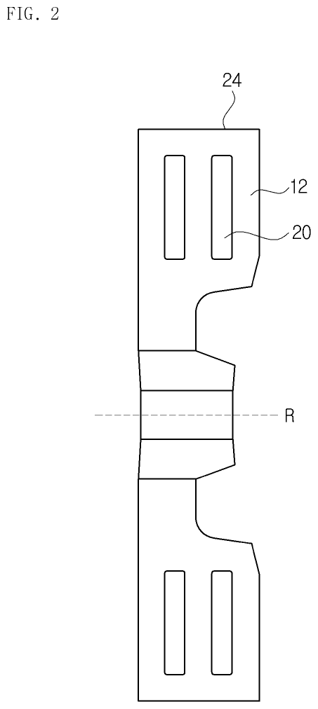

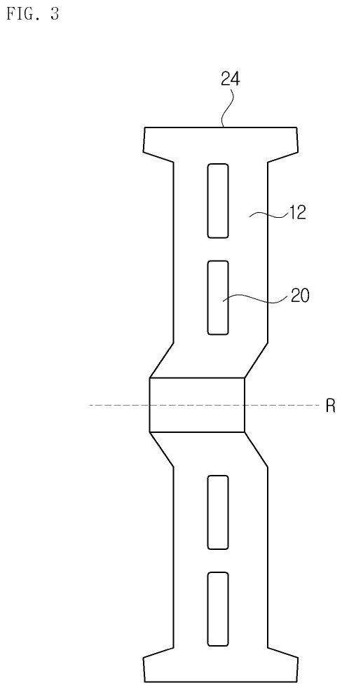

FIGS. 1-4 are sectional views of brake discs 12 for disc brake arrangements 10 according to embodiments of the invention. The disc brake arrangements 10 also each comprise a brake pad 14 that is schematically illustrated only in FIG. 1, but is to be provided at a similar position in FIGS. 2-4 as well. The brake disc 12 is a single- or multi-part member made from a metallic material. It is configured to rotate about a rotational axis R. The sectional plane extends radially and comprises the rotational axis R.

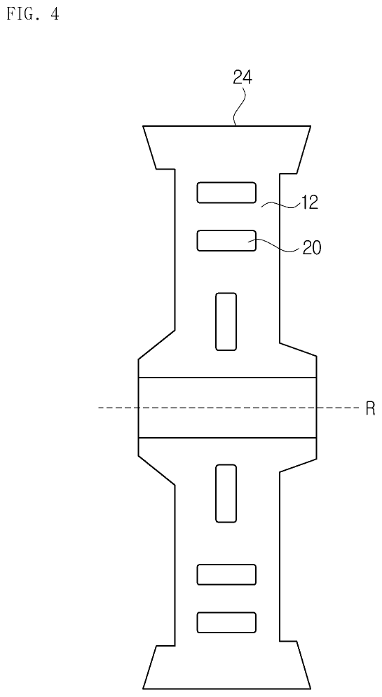

As indicated in FIG. 1, the brake disc 12 comprises a central hub 18 that is configured as a wheel hub for mounting a non-illustrated vehicle wheel thereto. The hub 18 forms a central axially protruding portion, which protrudes in only one axial direction in FIG. 1 and in two axial directions in FIG. 4. The brake disc 12 has a number of hollow portions 20, selected ones of which are marked by a respective reference sign in the figures.

In FIG. 1, side faces 22 of the brake disc 12 are marked. The brake discs 12 of FIGS. 1-4 each comprise an outer circumferential surface 24 that extends in a ring-like manner around the rotational axis R. The brake pad 14 is generally configured to generate brake forces by contacting said outer circumferential surface 24.

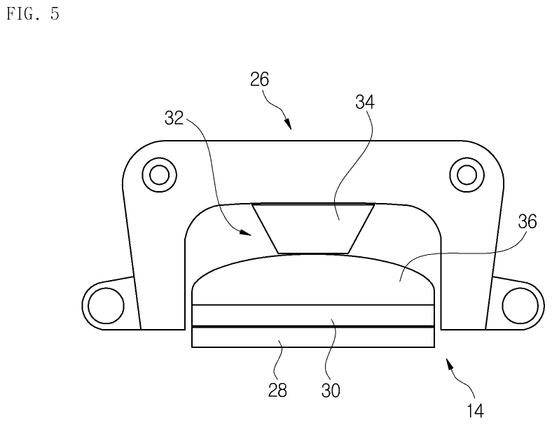

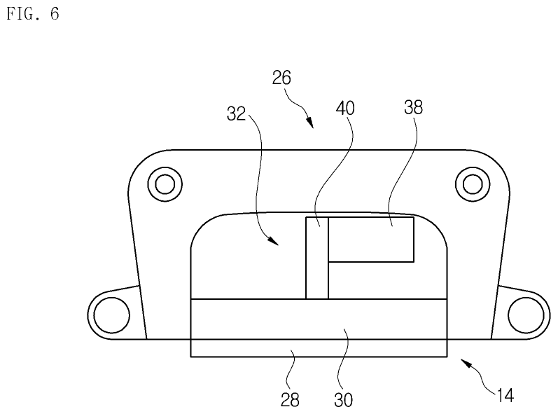

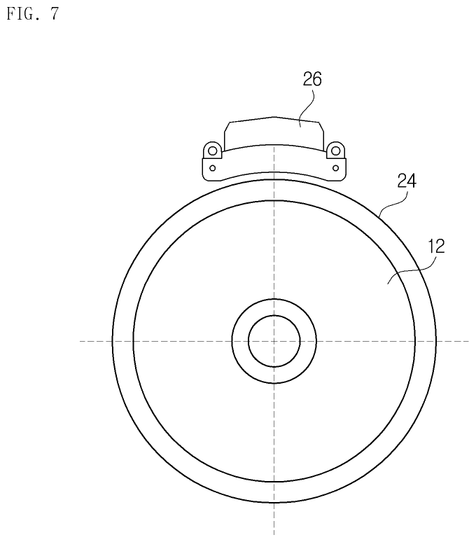

FIGS. 5 and 6 show exemplary embodiments of the brake pad 14 of FIG. 1 and a brake pad carrier 26 (or brake caliper) to which said brake pad 14 is mounted. In the shown examples, the brake pad 14 comprises a brake lining 28 and a back plate 30. The brake lining 28 comprises a friction material for contacting the outer circumferential face 24 of the brake disc 12 (see FIG. 1). The orientation of the brake pad 14 corresponds to that of FIG. 1, i.e. with a non-depicted rotation axis R extending horizontally. Note that at least the brake pad 14 is depicted in a similar sectional view as in FIG. 1. The surface of the brake lining 28 that contacts the outer circumferential face 24 is actually curved as e.g. evident from FIGS. 7 to 9 discussed below.

The brake pad carrier 26 also comprises an actuator 32 for radially displacing the brake pad 14 towards and away from the outer circumferential face 24 of the brake disc 12 (see FIG. 1). In FIG. 5, the actuator 32 is hydraulic. It comprises a brake fluid inlet 34 and a fluidically displaceable brake piston 36. In FIG. 6, the actuator 32 is electric. It comprises an electric motor and/or gear mechanism 38 and a spindle 40. Generally, the brake pad carrier 26 (which by way of example has a hollow and/or arc shaped housing) is fixed within the vehicle, e.g. to non-depicted axle components.

FIGS. 7-9 illustrate examples of arranging one or more brake pad carriers 26 and brake pads 14 (obstructed by the brake pad carriers 26 in said figures) relative to the brake disc 12. The viewing angle differs from the previous FIGS. in that the non-marked rotation axis R at the center of the brake disc 12 extends orthogonally to the image plane.

One can see that the radially inner face of the brake pad carrier 26 which lies opposite to the outer circumferential face 24 of the brake disc 12 is curved similarly to said outer circumferential face 24. The obstructed brake lining 22 is curved similar to said radially inner face, i.e. concavely with a curvature matching that of the outer circumferential face 24. This way, a large contact area between the brake lining 22 and outer circumferential face 24 is defined. Said contact area extends in the axial direction (preferably along the complete axial width of the brake lining 22 and/or outer circumferential face 24) and in the circumferential direction.

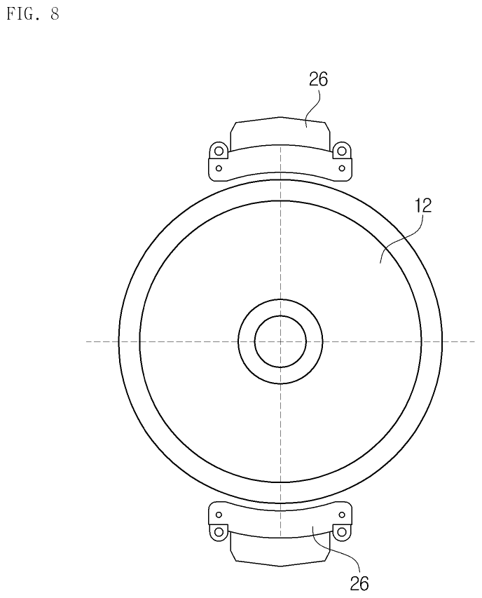

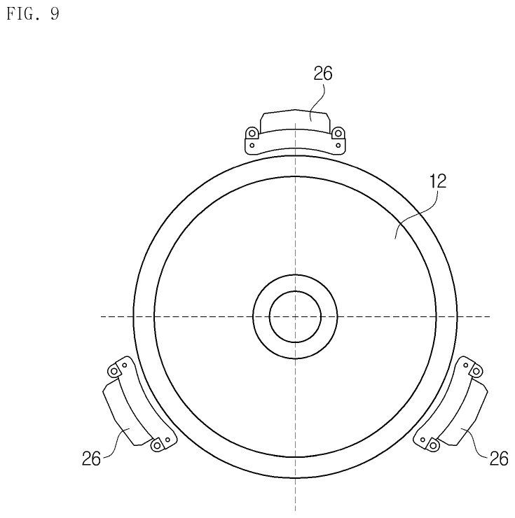

In FIG. 8, two brake pad carriers 26 each comprising an obstructed brake pad 14 are arranged 180° apart from one another along the outer circumferential face 24 of the brake disc 12. In FIG. 9, three brake pad carriers 26 are arranged 120° apart from one another along the outer circumferential face 24. Generally, any plurality of brake pad carriers 26 may be distributed at equal angular distances from one another along the outer circumferential face 24.

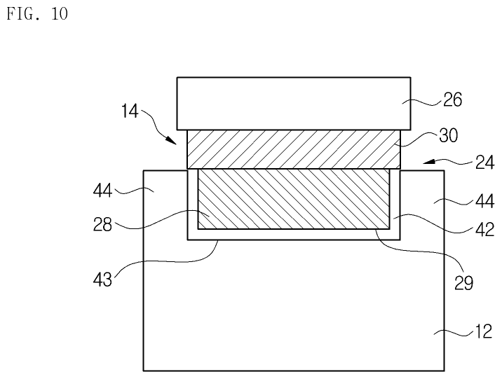

FIG. 10 shows a partial view of a brake disc arrangement 10 according to one embodiment that may be combined with the features of any of the previous embodiments. The view is a sectional view similar to FIG. 1 and with only part of a radially outer portion of the brake disc 12 being included. The brake disc 12 and specifically its outer circumferential face 24 comprises a recess 42 extending along the complete circumference in a closed ring-like manner. The brake pad 14 is at least partially received in said recess, optionally also when not braking. In the depicted example, the brake pad 14 comprises an optional back plate 30 and a brake lining 28. The brake lining 28, just like the recess 42, can again be curved as explained with reference to FIGS. 7-9.

The recess 42 has side portions or edge portions 44 that radially protrude outwards relative to a bottom face 43 of the recess 42. The edge portions 44 are axially spaced apart and receive the brake lining 22 in between them. They (at least axially) shield the brake lining 22 and in a particular its contact surface 29 facing the bottom face 43 from the surrounding. The edge portions 44 thus form shielding portions mentioned above. This helps to limit brake dust emissions and noise emissions.

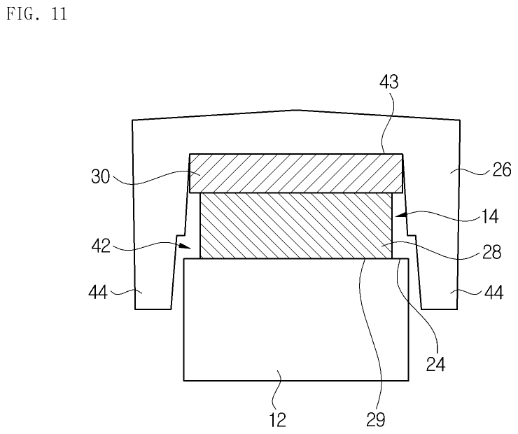

FIG. 11 shows a partial view of a brake disc arrangement 10, the view being similarly oriented to FIG. 1. In this case, the brake pad carrier 26 to which the brake pad 14 is mounted comprises a recess 42. In said recess 42, the brake pad 14 is (in particular fully) received. Also, a radial outer section and in particular an opposite section of the outer circumferential face 24 are received in said recess 42, in particular also when not breaking. Again, the recess 42 has side portions or edge portions 44. These protrude radially inwards relative to a bottom face 43 of the recess 42.

The edge portions 44 radially overlap part of the brake disc 12. Again, they thus shield a contact surface 29 of the brake lining 28 and also the section of the outer circumferential face 24 received in the recess 42 from the surroundings. This limits noise and brake dust emissions. The edge portions 44 thus again form shielding portions mentioned above.

Note that FIG. 10 depicts a non-braking state, whereas FIGS. 11-13 depict a braking state with the brake lining 28 contacting the outer circumferential face 24.

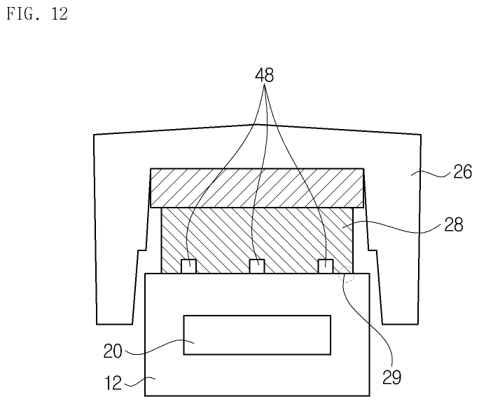

FIG. 12 is an optional development of the embodiment of FIG. 11. As an additional feature, the brake lining 28 and in particular its contact surface 29 for contacting the outer circumferential face 24 comprises at least one groove 48 (e.g. one central or a plurality of spaced apparat grooves 48). In FIG. 12, three grooves 48 are provided which each extend circumferentially and which each are curved similar to the contact surface 29 of the brake lining 28, said curvature being explained with respect to FIGS. 7-9 above. The grooves 48 have a dust guiding function and help to improve vibration and noise characteristics. Providing grooves 48 is not limited to the further details of FIGS. 11 and 12 and can also be included in any other embodiment disclosed herein. As a merely optional feature, the depicted part of the brake disc 12 again comprises a hollow portion 20 similar to FIGS. 1-4.

FIG. 12 is another optional development of the embodiment of FIG. 11. As an additional feature, dust collecting members 50 (e.g. comprising adhesive and/or porous materials) are provided at the inner side of each edge portion 44 and face the outer circumferential face 24 of the brake disc 12. Providing dust collecting members 50 is not limited to the further details of FIGS. 11 and 12 and can also be included in any other embodiment disclosed herein.

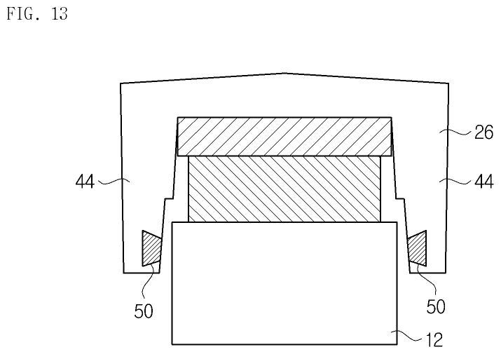

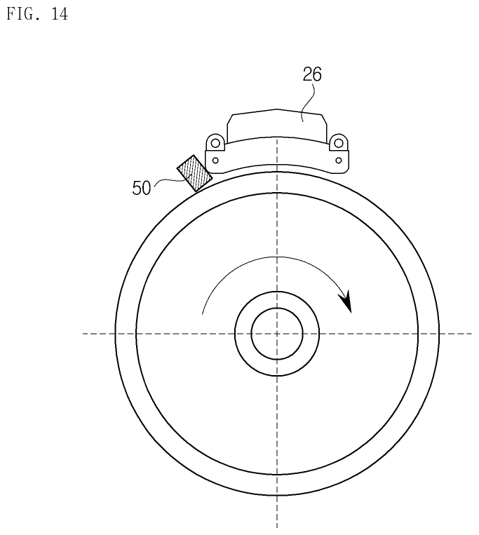

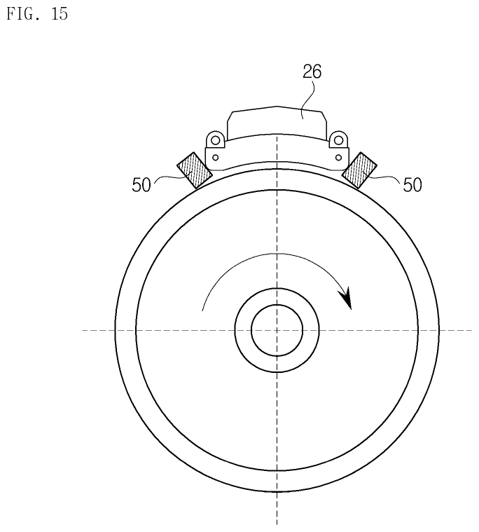

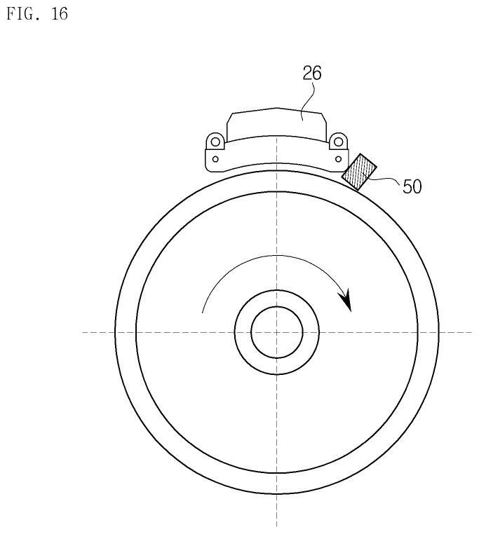

FIGS. 14-16 depicted alternative positions of dust collecting members 50 which may be provided additionally or alternatively to the dust collecting members 50 of FIG. 13. In FIGS. 14-16, the dust collecting members 50 are provided at outer faces or outer edges of the brake pad carrier 26. With reference to a forward rotation direction indicated by an arrow in FIGS. 14-16, FIG. 14 shows a dust collecting member 50 at a trailing edge of the brake pad carrier 26, FIG. 16 shows a dust collecting member 50 at a leading edge of the brake pad carrier 26 and FIG. 15 shows dust collecting members 50 at both of these edges.

What is claimed is:

1. Disc brake arrangement for a vehicle, in particular a road vehicle, comprising:
a brake disc that is rotatable about a rotation axis;
at least one brake pad having a brake lining and being movable to contact an outer circumferential face of the brake disc for generating a brake force.

2. The disc brake arrangement according to claim 1,
wherein the brake lining comprises a friction material.

3. The disc brake arrangement according to claim 1,
wherein the outer circumferential face of the brake disc is made from a material that is different from the material of the brake lining.

4. The disc brake arrangement according to claim 3,
wherein the outer circumferential face of the brake disc comprises a material that is harder than a material of the brake lining.

5. The disc brake arrangement according to claim 1,
wherein the brake disc comprises a metallic material or is a one-piece metallic member.

6. The disc brake arrangement according to claim 1,
wherein the brake lining has a contact surface for contacting the outer circumferential face of the brake disc, the contact surface being curved correspondingly to said outer circumferential face.

7. The disc brake arrangement according to claim 1,
further comprising at least one brake pad carrier to which the brake pad is mounted, the brake pad carrier having at least one shielding section that radially protrudes inwardly relative to the brake lining.

8. The disc brake arrangement according to claim 7,
wherein the shielding section is arranged or arrangeable axially adjacent to a section of the outer circumferential face of the brake disc.

9. The disc brake arrangement according to claim 1,
wherein the brake pad carrier comprises at least one dust collecting member.

10. The disc brake arrangement according to claim 9,
wherein the at least one dust collecting member is placed at one of a trailing edge or leading edge of the brake pad carrier with respect to a forward rotating direction of the brake disc.

11. The disc brake arrangement according to claim 7,
wherein the brake pad carrier comprises at least one dust collecting member and,
wherein the at least one dust collecting member is placed at an inner side of the shielding section according to claim 7, said inner side facing the brake disc.

12. The disc brake arrangement according to claim 1,
wherein the outer circumferential face of the brake disc comprises a recess in which the brake pad is at least partially received or receivable.

13. The disc brake arrangement according to claim 1,
wherein a contact surface of the brake lining for contacting the outer circumferential face of the brake disc comprises at least one groove.
